(19) United States
(12) Patent Application Publication
(10) Pub. No.: US 2026/0037677 A1
(43) Pub. Date: Feb. 5, 2026

(54) SELF-ENCRYPTING STORAGE DEVICE AND OPERATION METHOD THEREOF

(71) Applicant: MAKTAR INC., New Taipei City (TW)

(72) Inventors: LIANG-HSIN CHEN, New Taipei City (TW); CHEN-FU TSAI, New Taipei City (TW); SHU-YU LIN, New Taipei City (TW)

(21) Appl. No.: 18/890,317

(22) Filed: Sep. 19, 2024

(30) Foreign Application Priority Data
Jul. 31, 2024 (TW) 113128550

(51) Int. Cl. G06F 21/78; G06F 21/60

(52) U.S. Cl. CPC G06F 21/78; G06F 21/602; G06F 21/606

(57) ABSTRACT

A self-encrypting storage device, comprising: a data storage device, for storing data and providing a self-encrypting function for the data; a control unit, connected to the data storage device through a first signal connection; and a wireless communication module, connected to the control unit through a second signal connection, wherein the wireless communication module receives a wireless signal from a first external device and converts the wireless signal into a wired signal transmitted to the control unit. When the wireless signal delivers a decryption command or an authorization information corresponding to the data storage device, the control unit transmits the decryption command or the authorization information to the data storage device. The data storage device then unlocks its self-encrypting function according to the decryption command or the authorization information, to retrieve an operation authority of at least one storage section in the data storage device.

### BACKGROUND OF THE INVENTION

### 1. Field of the Invention

The present invention provides a self-encrypting storage device that retrieves operation authority within the self-encrypting storage device through a decryption command from an external device.

### 2. Description of the Prior Art

Storage data security is one of the key points of information security. Particularly when valuable data is stolen, the loss can be very severe. Especially for portable data storage devices, they are easily forgotten during movement, potentially leading to the leakage of important information.

Self-encrypting drives, whose authentication systems maintain the security of internal data, can enhance the security of data preservation in portable data storage devices. However, there are still some concerns. The authentication system has no dependency on the host computer to which the self-encrypting drive is connected. In some operation schemes, decryption commands or authentication information still need to be transmitted through the host computer to unlock the self-encrypting drive. As such, decryption commands or authentication information may still be sniffed in the host computer, leading to data leakage from the portable data storage device, raising security concerns.

Furthermore, if a conventional portable data storage device is stolen and its casing is damaged, malicious individuals can easily attempt to decrypt and read the internal components, creating a risk of data leakage. If these are important confidential files of a company, the resulting losses would be difficult to estimate.

### SUMMARY OF THE INVENTION

Regarding the aforementioned technical needs, the present invention provides a self-encrypting storage device, comprising: a data storage device, for storing data and providing a self-encrypting function for the data; a control unit, connected to the data storage device through a first signal connection; and a wireless communication module, connected to the control unit through a second signal connection, wherein the wireless communication module receives a wireless signal from a first external device and converts the wireless signal into a wired signal transmitted to the control unit. When the wireless signal delivers a decryption command or an authorization information corresponding to the data storage device, the control unit transmits the decryption command or the authorization information to the data storage device, and the data storage device unlocks the self-encrypting function according to the decryption command or the authorization information, to retrieve an operation authority of at least one storage section in the data storage device.

In one embodiment, when the wireless signal includes the decryption command or the authorization information, the data storage device performs an authorized operation on the at least one storage section according to the operation authority. Alternatively, the self-encrypting storage device further comprises a connector or a signal bridge, wherein the control unit forms a signal channel with a second external device through the connector or the signal bridge. When the wireless signal comprises the decryption command or the authorization information, the second external device performs the authorized operation on the at least one storage section of the data storage device under the operation authority through the signal channel.

In one embodiment, the control unit determines a distance between the self-encrypting storage device and the first external device based on the strength of the wireless signal received by the wireless communication module. When the connector is not plugged in the second external device and the distance between the unlocked self-encrypting storage device and the first external device is greater than a safety distance, the control unit issues a security alert. Alternatively, when the control unit does not form a signal channel with the second external device through the signal bridge and the distance between the unlocked self-encrypting storage device and the first external device is greater than a safety distance, the control unit issues a security alert.

In one embodiment, the second external device comprises: a computer, a peripheral storage device, a tablet computer, a smartphone, a display, or a printer, which are devices capable of sending a decryption command or authorization information corresponding to the data storage device via the wireless signal.

In one embodiment, the data storage device is a self-encrypting drive compliant with TCG Opal 2.0 specification. TCG refers to the specification of Trusted Computing Group.

In one embodiment, the operation authority comprises read permission, write permission, modify permission, and execute permission.

In one embodiment, the data can be digital data or analog data.

In one embodiment, the second external device comprises: a computer, a peripheral storage device, a tablet computer, a smartphone, a display, or a printer.

In one embodiment, the first and second signal connections are respectively a wired connection or a wireless connection.

In one embodiment, the wireless signal comprises: NFC, Bluetooth, or other similar communication protocols.

In one embodiment, the self-encrypting function performs encryption and decryption based on at least one of Advanced Encryption Standard (AES) and RSA encryption standard.

According to another aspect, the present invention provides a method for operating a self-encrypting storage, comprising: providing a data storage device and providing a self-encrypting function for data stored in the data storage device;

providing a first signal connection and a control unit, the control unit connected to the data storage device through the first signal connection; providing a second signal connection and a wireless communication module, the wireless communication module connected to the control unit through the second signal connection; and the wireless communication module receiving a wireless signal from a first external device and converting the wireless signal into a wired signal transmitted to the control unit, wherein when the wireless signal delivers a decryption command or an authorization information corresponding to the data storage device, the data storage device unlocks the self-encrypting function of the data storage device according to the decryption command or the authorization information, to retrieve an operation authority of at least one storage section in the data storage device.

Through the self-encrypting storage device and the method for operating a self-encrypting storage provided by the present invention, it is possible to prevent the encrypted data from being decrypted and stolen when the present invention is stolen and its casing is damaged.

### BRIEF DESCRIPTION OF THE DRAWINGS

FIGS. 1 and 2 illustrate schematic diagrams of self-encrypting storage devices according to multiple embodiments of the present invention;

FIG. 3 illustrates a schematic diagram of the distance between the self-encrypting storage device and the first external device according to an embodiment of the present invention;

FIG. 4 illustrates a schematic diagram of the encryption and decryption process in the self-encrypting drive according to an embodiment of the present invention; and

FIG. 5 illustrates a flow chart of a method for operating a self-encrypting storage according to an embodiment of the present invention.

### DETAILED DESCRIPTION OF THE PREFERRED EMBODIMENTS

The aforementioned and other technical content, features, and effects of the present invention will be clearly presented in the following detailed description of the preferred embodiments with reference to the accompanying drawings.

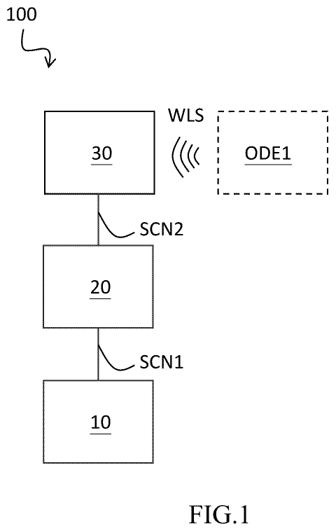

Referring to FIG. 1, regarding the aforementioned technical needs, the present invention provides a self-encrypting storage device 100, comprising: a data storage device 10, for storing data and providing a self-encrypting function for the data; a control unit 20, connected to the data storage device 10 through a first signal connection SCN1; and a wireless communication module 30, connected to the control unit 20 through a second signal connection SCN2. The wireless communication module 30 receives a wireless signal WLS from a first external device ODE1 and converts the wireless signal WLS into a wired signal transmitted to the control unit 20. When the wireless signal WLS delivers a decryption command or an authorization information corresponding to the data storage device 10, the data storage device 10 unlocks the self-encrypting function of the data storage device 10 according to the decryption command or the authorization information (for example, the control unit 20 transmits the decryption command or the authorization information to the data storage device 10. Alternatively, said control unit 20 generates an unlock command to the data storage device 10 based on the decryption command or the authorization information), to retrieve an operation authority of at least one storage section in the data storage device 10. Wherein, corresponding to different users, different data or sections in the data storage device 10 may have different security permissions. Therefore, the decryption command or the authorization information (or the unlock command) may correspond to only different data or different storage sections therein, thus unlocking the operation authority of at least one storage section in the data storage device 10 for operation.

Furthermore, the design of operation authority for at least one storage section can greatly improve the usage efficiency of the data storage device 10. By having different security settings for different data or different storage sections, the self-encrypting storage device 100 can have the flexibility of various security settings.

In one embodiment, when the wireless signal WLS includes the decryption command or the authorization information, the data storage device 10 performs an authorized operation on the at least one storage section according to the operation authority (for example, the data storage device 10 performs a self-authorized operation, or operates through the first external device ODE1 to perform an authorized operation on the data storage device 10).

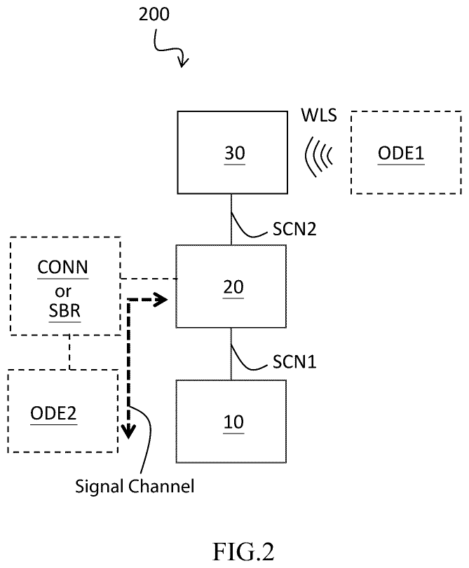

Compared to the self-encrypting storage device 100 in FIG. 1, FIG. 2 shows an embodiment where the self-encrypting storage device 200 further comprises a connector CONN or a signal bridge SBR. The control unit 20 forms a signal channel with a second external device ODE2 through the connector CONN or the signal bridge SBR (for example, the connector CONN is plugged into the second external device ODE2 to form a signal channel between the self-encrypting storage device 100 and the second external device ODE2). When the wireless signal WLS includes the decryption command or the authorization information, the second external device ODE2 performs the authorized operation on the at least one storage section of the data storage device 10 under the operation authority through the signal channel.

In one embodiment, if there is a need for enhanced security, the signal connection between the first external device ODE1 and the self-encrypting storage device 100, 200, in addition to the aforementioned wireless signal WLS, can be supplemented with other signals to assist in transmitting the decryption command or the authorization information, such as optical signals in the form of images or animations, mechanical vibrations, sounds, videos, biometric recognition, etc., reducing the possibility of information theft and enhancing the strength of data confidentiality.

The aforementioned self-encrypting function, for example, automatically encrypts (auto-locks) the data storage device 10 when in a static state, such as when the connector CONN or the signal bridge SBR disconnects from the second external device ODE2 (for example, when the connector CONN is unplugged from the second external device ODE2). If the data storage device 10 is damaged, it can only be unlocked through the wireless communication module 30 receiving the wireless signal WLS from the first external device ODE1, otherwise, the data storage device cannot be read.

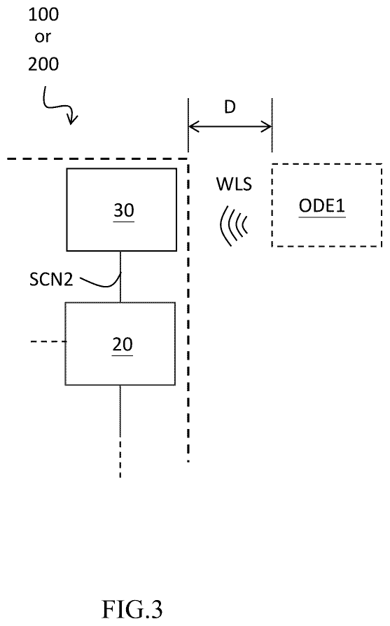

Referring to FIG. 3, based on the need for enhanced data security, in one embodiment, the control unit 20 determines a distance D between the self-encrypting storage device 100 and the first external device ODE1 based on the strength of the wireless signal WLS received by the wireless communication module 30. When the strength of the received wireless signal WLS decreases, it indicates that the distance D between the self-encrypting storage device 100 and the external device ODE1 is increasing. When the strength of the received wireless signal WLS increases, it indicates that the distance D between the self-encrypting storage device 100 and the first external device ODE1 is decreasing. In this way, the distance D between the self-encrypting storage device 100 and the first external device ODE1 can be determined. This technology can also be used to prevent theft of the self-encrypting storage device 100. For example, when the distance D between the self-encrypting storage device 100 (or 200) and the first external device ODE1 is greater than a safety distance, the control unit 20 issues a security alert to warn that the self-encrypting storage device 100 may have been taken away from the scene. Another example, when the connector CONN is not plugged into the second external device ODE2, and the distance D between the self-encrypting storage device 100 that is unlocked and the first external device ODE1 is greater than a safety distance, the control unit issues a security alert. Various forms of security alerts can be issued, such as vibration, flashing light, sound, sending signals to said first external device ODE1, etc. Alternatively, when the control unit 20 does not form a signal channel with the second external device ODE2 through the signal bridge SBR, and the distance D between the self-encrypting storage device 100 that is unlocked and the first external device ODE1 is greater than a safety distance, the control unit 20 issues a security alert. This design can address situations where the self-encrypting function fails (system malfunction, settings changed, etc.), leading to increased theft risk, providing a double protection function after use and separation.

In one embodiment, the second external device ODE2 comprises: a computer, a peripheral storage device, a tablet computer, a smartphone, a display, or a printer, mainly including devices capable of sending the decryption command or the authorization information corresponding to the data storage device 10 via the wireless signal WLS.

In one embodiment, the data storage device 10 is a self-encrypting drive compliant with TCG Opal 2.0 specification.

In TCG Opal 2.0, a Media Encryption Key (MEK) among the encryption keys is the primary key for protecting static data in the data storage device 10. Static refers to data that is not in a state of being operated upon. The generation of the MEK can be performed in many ways, such as through a random number generator.

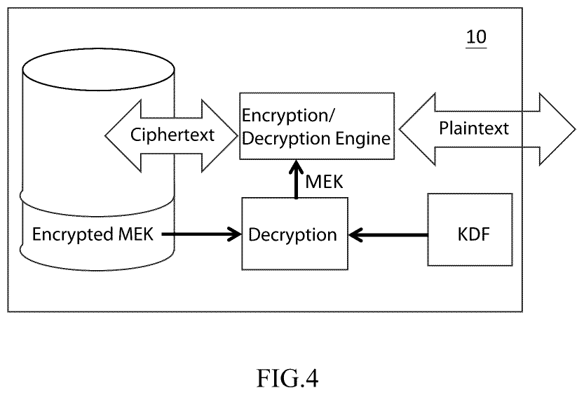

Referring to FIG. 4, the MEK, being crucial for protecting static data in the data storage device 10, also needs to be encrypted itself. The encryption of the MEK is performed using a Key Encryption Key (KEK). The KEK is a specific value that is generated based on the user's password, command, or calculation. The KEK is generated according to a Key Derivation Function (KDF). The MEK is only stored in an encrypted form in the self-encrypting storage device 100, and any unencrypted MEK only exists when the self-encrypting storage device 100 is powered on. When the self-encrypting storage device 100 is powered off, the unencrypted MEK is lost. Furthermore, TCG Opal 2.0 does not store unencrypted user passwords or commands, thus reducing the possibility of information leakage from the self-encrypting storage device 100.

In one embodiment, the operation authority includes read permission, write permission, modify permission, and execute permission. The authorized operations correspond respectively to these operation authorities, performing operations such as reading, writing, modifying, and executing on at least one storage section in the data storage device 10. If needed, it is not limited to these, for example, multiple encryptions can be performed.

In one embodiment, the aforementioned data can be digital data or analog data. The methods of data storage can be, for example: electrophysical methods (voltage, resistance, capacitance, electromagnetic, quantum state), optical physical methods, chemical methods, mechanical methods, etc.

In one embodiment, the second external device ODE2 includes: a computer, a peripheral storage device, a tablet computer, a smartphone, a display, or a printer.

In one embodiment, the data storage device 10 is a self-encrypting drive compliant with TCG Opal 2.0 specification. For example, a self-encrypting SSD drive (SATA drive or NVMe drive). For instance, NVMe drives, based on NAND, can transfer data through high-speed PCIe slots to CPU, increasing the data transfer amount by tens of times compared to SATA drives. NVMe drives can process over a million input/output operations per second (IOPS). Compared to NVMe drives, SATA drives have a more traditional architecture, and many devices still use SATA drives currently.

In one embodiment, the first and second signal connections SCN1, SCN2 can be respectively a wired connection or a wireless connection. The choice of connection method can be determined based on requirements. For example, in wired connections, the internal design of the self-encrypting storage device is more compact, but the connection content is less likely to be sniffed. In wireless connections, the internal design of the self-encrypting storage device is more flexible, but the connection content is more easily sniffed. Furthermore, when the first and second signal connections SCN1, SCN2 are wired connections, their communication protocols can be determined as needed, such as I2C, SPI, or other wired transmission methods.

In one embodiment, the wireless signal WLS includes: NFC, Bluetooth, or other similar communication protocols.

In one embodiment, the self-encrypting function performs encryption and decryption based on at least one of Advanced Encryption Standard (AES) and RSA encryption standard.

In one embodiment, if needed, the first external device ODE1 and the second external device ODE2 can be the same device. For example, this same device can communicate with the wireless communication module 30 via the wireless signal WLS using the aforementioned NFC, Bluetooth, or other similar communication protocols. In this case, the signal bridge SBR can be combined with the wireless communication module 30, and this same device makes signal connection to the data storage device 10 via the wireless signal WLS to perform operations.

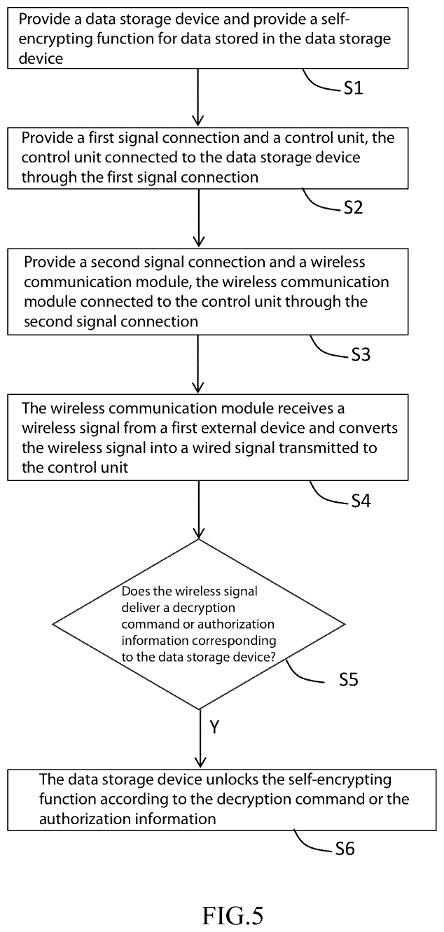

Referring to FIG. 5, according to another aspect, the present invention provides a method for operating a self-encrypting storage, comprising: providing a data storage device 10 and providing a self-encrypting function for data stored in the data storage device 10 (S1); providing a first signal connection SCN1 and a control unit 20, the control unit 20 connected to the data storage device 10 through the first signal connection SCN1 (S2); providing a second signal connection SCN2 and a wireless communication module 30, the wireless communication module 30 connected to the control unit 20 through the second signal connection SCN2 (S3); the wireless communication module 30 receiving a wireless signal WLS from a first external device ODE1 and converting the wireless signal WLS into a wired signal transmitted to the control unit 20 (S4); and when the wireless signal WLS delivers a decryption command or an authorization information corresponding to the data storage device 10 (S5), the data storage device 10 unlocks the self-encrypting function of the data storage device 10 according to the decryption command or the authorization information (S6), to retrieve an operation authority of at least one storage section in the data storage device 10.

For detailed descriptions of the method for operating a self-encrypting storage, please refer to the aforementioned related embodiments and component descriptions, which will not be repeated here. The main technical means of the present invention lies in the self-encrypting function of the data storage device 10 (S1). If malicious individuals destroy the product casing and disassemble the components separately, they still cannot read the data in the data storage device 10, whether through the control unit 20, the wireless communication module 30, or by disassembling the data storage device 10 alone.

The above has described the present invention in terms of preferred embodiments. However, what has been stated above is only to enable those skilled in the art to easily understand the content of the present invention and is not intended to limit the scope of rights of the present invention or the disclosed technology. Any skilled person familiar with the art can make combinations, slight modifications, or equivalent variations to form equivalent embodiments within the scope of the technical solution of the present application.

What is claimed is:

1. A self-encrypting storage device, comprising:
a data storage device, for storing data and providing a self-encrypting function for the data;
a control unit, connected to the data storage device through a first signal connection; and
a wireless communication module, connected to the control unit through a second signal connection, wherein the wireless communication module receives a wireless signal from a first external device and converts the wireless signal into a wired signal transmitted to the control unit, wherein when the wireless signal delivers a decryption command or an authorization information corresponding to the data storage device, the data storage device unlocks the self-encrypting function according to the decryption command or the authorization information, to retrieve an operation authority of at least one storage section in the data storage device.

2. The self-encrypting storage device of claim 1, wherein when the wireless signal includes the decryption command or the authorization information, the data storage device performs an authorized operation on the at least one storage section according to the operation authority; or, the self-encrypting storage device further comprises a connector or a signal bridge for plugging in a second external device, wherein the control unit forms a signal channel with the second external device through the connector or the signal bridge, wherein when the wireless signal includes the decryption command or the authorization information, the second external device performs the authorized operation on the at least one storage section of the data storage device under the operation authority through the signal channel.

3. The self-encrypting storage device of claim 1, wherein the control unit determines a distance between the self-encrypting storage device and the first external device based on the strength of the wireless signal received by the wireless communication module, wherein when the distance between the self-encrypting storage device that is unlocked and the first external device is greater than a safety distance, the control unit issues a security alert.

4. The self-encrypting storage device of claim 1, wherein the second external device comprises: a computer, a peripheral storage device, a tablet computer, a smartphone, a display, or a printer.

5. The self-encrypting storage device of claim 1, wherein the data storage device is a self-encrypting drive compliant with TCG Opal 2.0 specification.

6. The self-encrypting storage device of claim 1, wherein the operation authority comprises read permission, write permission, modify permission, and execute permission.

7. The self-encrypting storage device of claim 1, wherein the data is digital data or analog data.

8. The self-encrypting storage device of claim 1, wherein the first and second signal connections are respectively a wired connection or a wireless connection.

9. The self-encrypting storage device of claim 1, wherein the wireless signal comprises: NFC, Bluetooth, or other similar communication protocols.

10. The self-encrypting storage device of claim 1, wherein the self-encrypting function performs encryption and decryption based on at least one of Advanced Encryption Standard (AES) and RSA encryption standard.

11. A method for operating a self-encrypting storage, comprising:
providing a data storage device and providing a self-encrypting function for data stored in the data storage device;
providing a first signal connection and a control unit, the control unit connected to the data storage device through the first signal connection;
providing a second signal connection and a wireless communication module, the wireless communication module connected to the control unit through the second signal connection; and
the wireless communication module receiving a wireless signal from a first external device and converting the wireless signal into a wired signal transmitted to the control unit, wherein when the wireless signal delivers a decryption command or an authorization information corresponding to the data storage device, the data storage device unlocks the self-encrypting function of the data storage device according to the decryption command or the authorization information, to retrieve an operation authority of at least one storage section in the data storage device.
